(19) United States
(12) Patent Application Publication
(10) Pub. No.: US 2006/0047733 A1
(43) Pub. Date: Mar. 2, 2006

(54) Method for representing integer and floating point numbers in a binary orderable format

(75) Inventors: Mark Warden Hervin, Plano, TX (US); Michael B. Early, Plano, TX (US)

Correspondence Address: DLA PIPER RUDNICK GRAY CARY US, LLP, 2000 UNIVERSITY AVENUE, E. PALO ALTO, CA, 94303-2248, US

(73) Assignee: Calpont Corporation, Rockwall, TX (US)

(21) Appl. No.: 10/926,650

(22) Filed: Aug. 26, 2004

(51) Int. Cl. G06F 7/00

(52) U.S. Cl. 708/204

(57) ABSTRACT

A method is described for converting standard integer and floating point formatted numbers to an improved integer and floating point numbers which are binary orderable. Standard integers are represented in two's complement format, to make standard integers binary orderable, the sign bit is flipped. To make floating point numbers binary orderable the implicit leading bit of the mantissa needs to be made explicit. Next the mantissa is converted to two's complement format, and the sign bit is flipped. Finally, for negative numbers the exponent is inverted, or XORed with all 1s.

### TECHNICAL FIELD OF THE INVENTION

The present invention relates to a method of internal data representation that allows integer and floating point numbers to be in binary order so that the numbers can be sorted and easily compared in binary form.

### BACKGROUND OF THE INVENTION

Numbers are stored in the binary memory used in computers in a variety of formats. Two of the most common formats are the integer format and the floating point format. The integer format is used to store whole numbers that can be represented by the number of binary bits available, usually 32 or 64. As can be seen in FIG. 1, in the standard integer format the first bit is the sign bit that represents whether the number is positive or negative with the remaining bits storing the whole number in binary form. Negative integers are stored in two's complement format to allow for simple additional and subtraction of numbers in binary form.

The other most common format for numbers is the floating point format set out in IEEE Standard 754. Floating point representation basically represents real numbers in scientific notation, which has a base number and an exponent, such as 5.5×10² to represent 550. Binary numbers are represented in base 2, instead of base 10 in the example. Floating point representation solves a number of problems. Fixed point formats, such as the integer format, has a fixed window of representation, which limits it from representing very large or very small numbers. Fixed point representations are also prone to a loss of precision when dividing, as with the integer format, when the result of the division is not a whole number. Floating point representation employs a sliding window of representation appropriate to the scale of the number.

The format can have 32 or 64 bits and the fields used in the format are shown in FIG. 2 with the corresponding bits in the fields (double precision bits are in parentheses). Floating point numbers have three basic fields: the sign, the exponent and the mantissa. As with the integer format the first bit is the sign bit, which, as with the integer, represents whether the number is positive or negative. Flipping the value of the sign bit changes the sign of the number. The exponent field takes the next eight bits in single precision (32 bits), or 11 bits for double precision (64 bits) floating point numbers. Since the exponent can be either negative or positive independent from the sign of the number itself, the exponent format uses a bias to eliminate the need for a sign bit on the exponent. The bias is added to the actual exponent to get the number stored in the exponent field. For single precision the bias is 127, and for double precision the bias is 1023, the notation for double precision is described as excess 1023 notation. Thus, an exponent of 0 means that 1023 will be stored in the exponent field. A value of 1500 in the exponent field means that the exponent is 477 (1500-1023). The bias allows exponents from −1023 to 1024 to be represented, though exponents of all zeros (−1023) and all 1s (1024) are reserved for special numbers.

The mantissa represents the precision bits of the number. It includes an implicit leading bit and the fractions bits. In order to maximize the quantity of the representable numbers, floating point numbers are typically stored in normalized form. This puts the radix point after the first non-zero digit. Since the only possible non-zero digit in base-two, or binary, is 1, we can assume a leading digit of 1 and don't have to store it explicitly. As a result the mantissa has effectively 53 bits of resolution by way of the 52 fraction bits stored in the double precision format.

The IEEE floating point standard reserves exponent fields of all zeros and all 1s to denote special values in the floating point scheme. One special value is zero. Because of the implicit leading 1 value zero cannot be explicitly represented, therefore zero is represented with an exponent field of zero and a fraction field of zero. Zero in this format can be either positive or negativw.

Another special value is infinity. The values +infinity and −infinity are denoted with an exponent of all ones and a fraction of all zeros. The sign bit distinguishes between positive and negative infinity. The value NaN (Not a Number) is used to represent a value that does not represent a real number, such as the result of dividing by zero. Finally, the last special numbers are denormalized numbers, which allow for gradual underflow. When a number reaches the largest negative exponent, represented by all zeros in the exponent field, then the implicit 1 is no longer considered present, allowing small numbers to be represented with a loss of precision instead of just being unrepresentable.

One characteristic of both the integer and floating point formats is that in neither format are the numbers ordered from a bit perspective, that is you can not sort the numbers simply by ordering them by their binary bits. Being able to bit order numbers would be advantageous in systems that stored values in memory locations associated with their values. Such applications could include hardware database management systems such as the one described in U.S. patent application Ser. No. 10/712,644. Accordingly, what is needed, therefore, is a method of representing integer and floating point numbers in a format that is naturally ordered according to the bit value.

### SUMMARY OF THE INVENTION

The present invention provides for a method of converting standard integers and standard floating point numbers into improved integer and improved floating point formats. In one embodiment of the invention a standard integer formatted number is converted into a binary orderable, or improved, integer number by accepting the standard integer number and then flipping the sign bit of the standard integer number resulting in a binary orderable integer formatted number.

In a second embodiment of the present invention a standard IEEE floating point number is converted into a binary orderable, or improved, floating point number by restoring the leading, or implicit, bit in the mantissa, or fraction of the floating point number. Next the mantissa is converted to two's complement format, and then the sign bit is flipped. After the sign bit is flipped, the method detects whether the number is positive or negative, and if the number is negative the exponent is inverted, or XORed with all 1s.

In the third embodiment of the present invention a method for creating a unified binary orderable number format is described. The method detects if the number to be converted is an integer or a floating point number, and if the number is an integer it is converted to a floating point number, and then converted into a binary orderable floating point number as described above.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art will appreciate that they can readily use the disclosed conception and specific embodiment as a basis for designing or modifying other structures for carrying out the same purposes of the present invention. Those skilled in the art will also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates the fields of a standard integer formatted number;

FIG. 2 illustrates the fields of a standard IEEE floating point number;

FIG. 3 illustrates a flow chart showing the conversion of standard integer number to a bit orderable integer format;

FIG. 4 illustrates a flow chart showing the conversion of a standard floating point number to a bit orderable floating point number; and

FIG. 5 illustrates a chart showing that integer and floating point numbers are in bit order after being converted in accordance with the present invention.

### DETAILED DESCRIPTION OF THE DRAWINGS

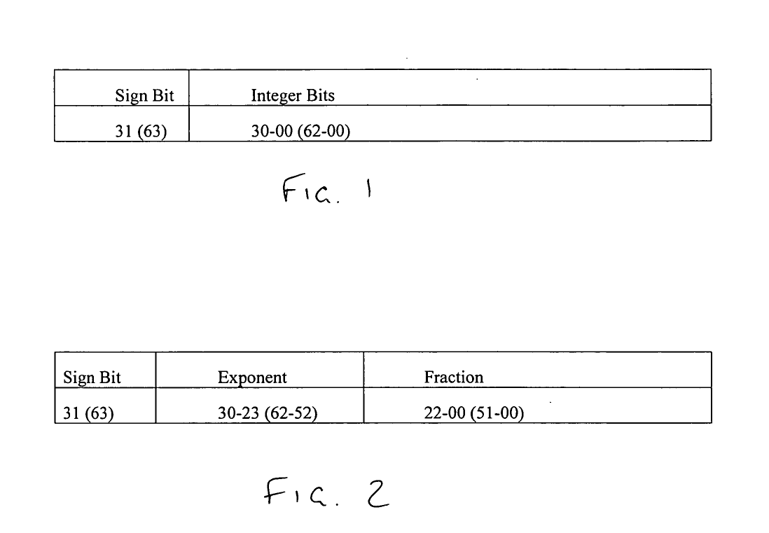

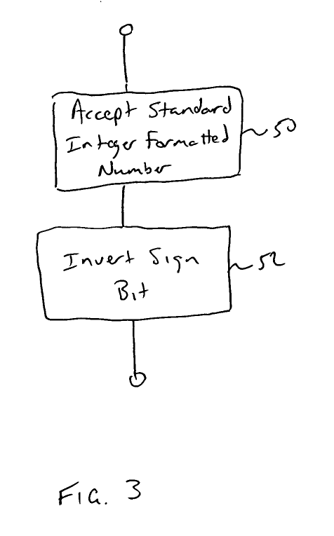

As stated above, the standard integer format is shown in FIG. 1. Normal integer representation is two's complement, with the high order bit is a sign bit, with 0 representing a positive number. This makes positive numbers less than negative numbers if they are put in binary order. To convert this to a binary orderable integer format, all that needs to be done is to flip the sign bit, so that positive numbers have a 1 in that bit (and negatives have a 0)

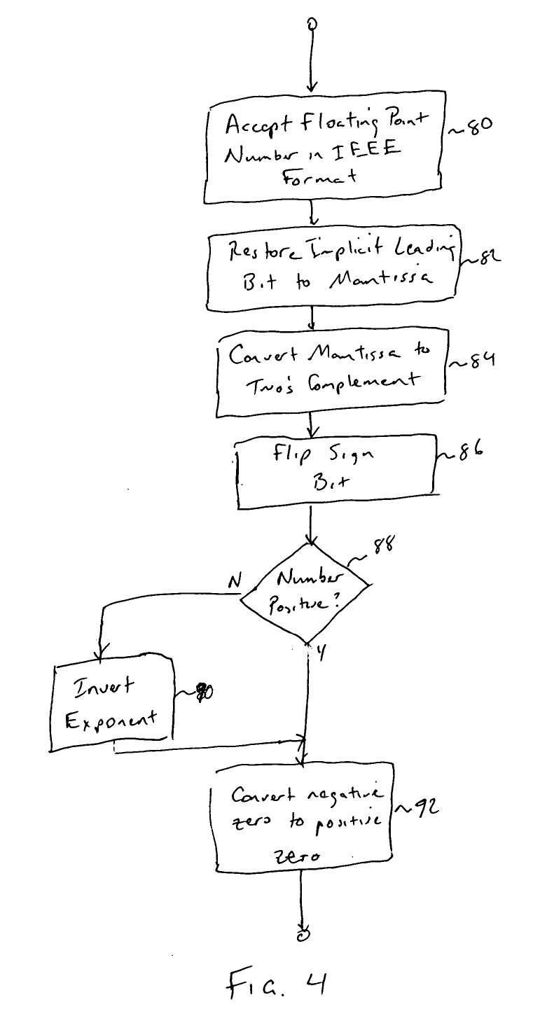

Referring now to FIG. 3, a method describing the conversion of a the standard integer format to a binary orderable integer format is shown. The method begins with block 50 where a standard integer formatted number is accepted. The method then passes to block 52 which inverts the sign bit of the standard integer formatted number. Referring now to the table shown in FIG. 5, one can see that integers in the binary orderable format of the present invention will be properly ordered, with smaller negative numbers ending up ahead of larger ones, and positive numbers ahead of negatives. The method works for both 32 bit integers as well as 64 bit integers.

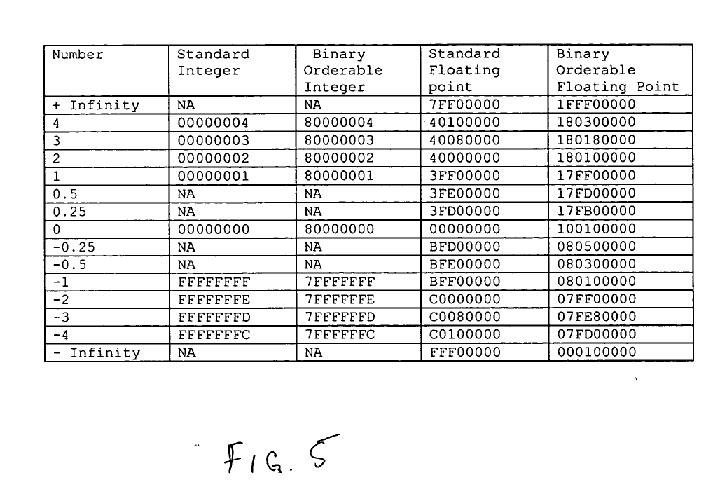

Referring now to FIG. 4 and the table shown in FIG. 5, a method of converting IEEE floating point numbers to a binary orderable format is described. Column 4, titled Standard Floating Point, show a sample of numbers in standard floating point format. As can be seen, this format does not order numbers properly from largest negative to largest positive. Several things need to be done to represent these numbers in a binary orderable format. The method of converting a floating point number to a binary orderable number in accordance with the present invention begins with block 80 of FIG. 4 which shows receiving a floating point number in IEEE format. Next the method passes to block 82, where the mantissa needs to have the implicit leading bit reinserted. This requires that the binary orderable format use 65 bits instead of 64 to preserve precision. The method then passes to block 84 where the mantissa is converted to two's complement form

From block 84 the method passes to block 86 which represents flipping the sign bit as is done with the integer representation (0=negative, 1=positive). The method then passes to decision block 88 where it is determined in the number is positive or negative. If the number is negative, the method passes to block 90 where the exponent is inverted, or XOR'ed with all 1's. After the exponent is inverted the method passes to block 92. For positive numbers, the method passes straight to block 92 since the excess 1023 notation is already in proper format −0 represents the smallest possible exponent, and 2047 the largest. However, for negative numbers the binary orderable format of the present invention requires exactly the opposite—small exponents need to be considered larger than large exponents. Inverting the exponent as shown in block 90 the exponent if negative accomplishes that. Infinity and NaNs also can be represented. NaNs will order as larger (or smaller) than +/−infinity.

Finally, the method passes to block 92 where minus zero is detected and converted to a normal zero. While this could be represented in the format above, it may present problems from a user standpoint since many users would not expect a result of negative zero. This binary orderable format of the present invention is preferably is 65 bits long, but can be 64 bits if losing one bit of precision in the fraction is acceptable in the particular application.

While having two separate formats—one for integer and one for floating point—would be the simplest, but if one format is desired, then the binary orderable format of the present invention can be modified to accommodate the sorting of integers and floating point numbers by modifying the binary orderable floating-point format of the present invention. The format must be expanded by growing the mantissa field from 53 bits to 64, so that 64-bit integers do not lose precision during the conversion process. After converting standard integers to floating point numbers, everything else is as described with reference to FIG. 4. This means that the combined binary orderable format with use 75 bits to preserve precision. Conversion from integer to/from this format can require a large shifter and leading one's detection.

Referring now to FIG. 5 a table demonstrating the binary orderable format according to the present invention is shown. Column 1, titled Number, shows exemplary numbers ordered from lowest (bottom) to highest (top). Column 2, titled Standard Integer, shows the numbers of column 1 represented in hexadecimal integer format. One can observe that the standard integer format does not order on a binary basis. Column 3, titled Binary Orderable Integer show the same integers of Column 2 formatted according to the method set out in FIG. 3. One can observe that the binary orderable integers order correctly from lowest to highest.

Column 4, titled Standard Floating Point, shows floating point numbers represented in IEEE format, as with the standard integer format, the IEEE formatted floating point numbers do not order on a binary basis. Column 5, titled Binary Orderable Floating Point, shows the floating point numbers of column 4 converted to the binary orderable format set forth in FIG. 4. As with the binary orderable integer format, the binary orderable floating point formatted numbers order correctly from lowest to highest. The binary orderable floating point numbers are represented in 65 bits to explicitly include the implicit leading one from the IEEE format.

Although particular references have been made to specific protocols, implementations and materials, those skilled in the art should understand that the method of the present invention can function with other number formats to create binary orderable formats, and in a variety of different implementations without departing from the scope of the invention in its broadest form.

We claim:

1. A method of converting a standard integer formatted number having integer bits in two's complement and a sign bit to an improved integer format in which the improved integer format bit orders from smallest to largest, the method comprising: flipping the sign bit on the standard integer formatted number.

2. A method of converting a standard floating point number having a sign bit, a mantissa and an exponent, to an improved floating point number in which the improved floating point number bit orders from smallest to largest, the method comprising:
restoring the leading bit in the mantissa;
representing the mantissa in two's complement;
flipping the sign bit; and
inverting the exponent of a negative number.

3. The method of claim 2 further comprising after inverting, converting negative zero into positive zero.

4. The method of claim 2 wherein the improved floating point number has one more bit than the standard sixty-four bit floating point number.

5. The method of claim 2 wherein the improved floating point number has one less bit of precision in the mantissa than the standard floating point number.

6. A method of converting integers, having a sign bit and integer bits, and standard floating point numbers, having a sign bit, a mantissa and an exponent, to an improved unified number format in which the improved unified number format bit orders from smallest to largest, the method comprising:
converting integers into floating point format;
restoring the leading bit in the mantissa;
representing the mantissa in two's complement;
flipping the sign bit; and
inverting the exponent of a negative number.

7. The method of claim 6 further comprising after inverting, converting negative zero into positive zero.

8. The method of claim 6 wherein the improved unified number format has twelve more bits than the standard sixty-four bit floating point number.

9. The method of claim 6 wherein the improved floating point number has twelve less bits of precision in the mantissa than the standard floating point number.
